(19) United States
(12) Patent Application Publication
(10) Pub. No.: US 2006/0020952 A1
(43) Pub. Date: Jan. 26, 2006

(54) OPTICAL CONTROL APPARATUS

(76) Inventor: Jui-Chiang Lin, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/904,977

(22) Filed: Dec. 8, 2004

(30) Foreign Application Priority Data
Jul. 21, 2004 (TW) 93121703

(51) Int. Cl. G11B 33/02

(52) U.S. Cl. 720/600

(57) ABSTRACT

An optical control apparatus for a disc drive is provided. The disc drive comprises a disc selecting mechanism, a driving module and a control module. The control module controls the operation of the driving module and the driving module drives the disc selecting mechanism. The optical control apparatus comprises an optical sensor and a plate. The optical sensor is electrically connected to the control module and adapted to emit and detect a light beam. Additionally, the plate and the disc selecting mechanism are driven by the driving module simultaneously, and the plate is driven by the driving module to rotate. At least a portion of the plate is disposed on the path of the light beam emitted from the optical sensor. The optical sensor has at least one detecting region. After the plate has rotated a predetermined angle, the optical sensor is able to detect the detecting region.

### CROSS-REFERENCE TO RELATED APPLICATION

This application claims the priority benefit of Taiwan application serial no. 93121703, filed Jul. 21, 2004.

### BACKGROUND OF THE INVENTION

1. Field of the Invention

The present invention relates to an optical control apparatus and disc selecting method. More particularly, the present invention relates to an optical control apparatus and disc selecting method for a disc drive.

2. Description of the Related Art

Optical disc is a storage medium that has many advantages over the conventional magnetic storage medium. Optical discs have a high storage capacity and are easy to handle, and the data recorded in optical discs can be safely stored for a long time. Most important of all, the optical discs are relatively cheap to manufacture. In the past, each disc drive is designed to accommodate a single optical disc only. Thus, if a user needs to reproduce data from another optical disc, the disc inside the disc drive has to be manually replaced. To minimize the amount of manual disc swapping, disc drives that can hold numerous optical discs at the same time have been developed.

FIG. 1 is a diagram showing the layout of components inside a conventional multi-disc drive. To simplify the explanations, the major components inside the multi-disc drive are shown in block format. As shown in FIG. 1, a conventional disc drive 100 comprises a disc cassette 110, an optical pick-up module 120, a disc selecting mechanism 130 and a detecting unit 140. The disc selecting mechanism 130 is adapted to operate within an operating space. The disc cassette 110 and the optical pick-up module 120 are disposed within the operating space of the disc selecting mechanism 130. The disc cassette 110 is designed to accommodate a plurality of optical discs. The disc selecting mechanism 130 is designed to transfer an optical disc from the disc cassette 110 to the optical pick-up module 120 or return the optical disc inside the optical pick-up module 120 back to the disc cassette 110. It should be noted that the disc selecting mechanism 130 must be raised or lowered to a suitable height level in the disc selection process before a required optical disc can be grasped. The disc selecting mechanism 130 is controlled by an output of the detecting unit 140 when moving to a predetermined height level.

FIG. 2A is a perspective view showing a portion of the structure of a conventional disc drive. As shown in FIGS. 1 and 2A, a conventional disc drive 100 has a control module 150, a driving motor 162 and a gear set 164 designed for moving the disc selecting mechanism 130 to a predetermined height level so that a particular optical disc can be grasped. The driving motor 162 drives the disc selecting mechanism 130 and an optical meter 144 through the gear set 164 simultaneously. The control module 150 is used for controlling the driving motor 162.

FIG. 2B is a perspective view showing the structure of a detecting unit inside a conventional disc drive. As shown in FIG. 2B, the detecting unit 140 mainly comprises an optical sensor 142 and an optical meter 144. The optical meter 144 has a plurality of indentations 144a that facilitate the optical sensor 142 to detect any movement in the optical meter 144. It should be noted that the height of the disc selecting mechanism 130 could be derived from the amount of movement in the optical meter 144 because the driving motor 162 drives the disc selecting mechanism 130 and the optical meter 144 simultaneously through the gear set 164. In the following, the structure and function of the detecting unit 140 is explained in more detail.

FIG. 3A is a diagram showing an optical meter in a position to block a light beam emitted from an optical sensor. FIG. 3B is a diagram showing an optical meter in a position to allow the passage of a light beam emitted from an optical sensor. As shown in FIGS. 3A and 3B, the optical sensor 142 comprises a light-emitting portion 142a and a light-detecting portion 142b. The light-emitting portion 142a is adapted to emit a beam of light 142c to the light-detecting portion 142b. The optical meter 144 is disposed between the light-emitting portion 142a and the light-detecting portion 142b. As shown in FIG. 3A, when the optical meter 144 blocks the light beam 142c emitted from the light-emitting portion 142a, the light-detecting portion 142b detects the absence of the light beam 142c. Hence, the driving motor 162 continues to drive the disc selecting mechanism 130 (shown in FIG. 1). When the optical meter 144 moves to a position where the light beam 142c is able to pass through an indentation 144a and reach the light-detecting portion 142b as shown in FIG. 3B, the optical sensor 142 outputs an electrical signal to the control module 136. According to the electrical signal generated by the optical sensor 142, the control module 150 is able to stop the driving motor 162 so that the disc selecting mechanism 130 is stationed at a suitable height level.

The number of indentations 144a in the optical meter 144 typically corresponds with the number of optical discs that can be stored inside the disc cassette 130. In other words, the number of indentations 144a and the length of the optical meter 144 are directly proportional to the disc storage capacity of the disc cassette 110. However, a long optical meter severely limits the reduction of size of the disc drive. Furthermore, if the number of optical discs designed to store inside the disc cassette 110 is changed, a different optical meter 144 is required to provide a correct disc selection. Therefore, disc drives designed to hold a different number of optical discs cannot use standardized optical meters 44 having a common configuration.

### SUMMARY OF THE INVENTION

Accordingly, the present invention is directed to provide an optical control apparatus for controlling the operation of a disc selecting mechanism so that the optical control apparatus requires a smaller operating space.

As embodied and broadly described herein, the invention provides an optical control apparatus for a disc driver. The disc driver comprises a disc selecting mechanism, a driving module, a control module, a disc cassette and a data processing module. The disc selecting mechanism is suitable to operate in an operating space. The disc cassette and the data processing module are disposed within the operating space. The control module controls the driving module, and the driving module drives the disc selecting mechanism. The optical control apparatus comprises an optical sensor and a plate. The optical sensor is electrically connected to the control module. The optical sensor is designed to emit a light beam and detect the light beam. In addition, the plate and the disc selecting mechanism are driven by the driving module simultaneously, and the plate is driven by the control module to rotate. At least a portion of the plate is disposed on the optical path of the light beam produced by the optical sensor. The plate has at least one detecting region. After the plate has rotated a predetermined angle, the optical sensor is able to detect the detecting region.

According to one embodiment of the present invention, the angle of rotation of the plate can be 360°, 180°, 120°, 90°, 72° or 60°, for example.

According to one embodiment of the present invention, the optical sensor comprises a light-emitting portion and a light-detecting portion disposed at each side of the plate and the detecting region is a transparent region, for example. Furthermore, the transparent region comprises at least a through hole. In another embodiment, the detecting region is an opaque region. In yet anther embodiment, the plate further comprises a non-detecting region and the detecting region is a protrusion from the edge of the non-detecting region.

According to one embodiment of the present invention, the optical sensor comprises a light-emitting portion and a light-detecting portion disposed at the same side of the plate and the detecting region is a reflecting region, for example. In another embodiment, the detecting region is a non-reflecting region. In yet anther embodiment, the plate further comprises a non-detecting region and the detecting region is a protrusion from the edge of the non-detecting region.

According to one embodiment of the present invention, the driving module comprises a gear set and a driving motor. The driving motor drives the plate and the disc selecting mechanism simultaneously through the gear set, and the control module controls the driving motor.

The present invention provides an alternative optical control apparatus for a disc drive. The disc drive comprises a disc selecting mechanism, a driving module, a control module, a disc cassette and a data processing module. The disc selecting mechanism is suitable to operate in an operating space. The disc cassette and the data processing module are disposed within the operating space of the disc selecting mechanism. The control module controls the driving module and the driving module drives the disc selecting mechanism. The optical control apparatus comprises an optical sensor and a light-blocking element. The optical sensor is electrically connected to the control module. The optical sensor is designed to emit a light beam and detect a returning light beam. In addition, the light-blocking element and the disc selecting mechanism are driven by the driving module simultaneously. The light-blocking element is driven by the driving module to rotate around a spin axle. The optical sensor is disposed on the moving path of the light-blocking element such that the light-blocking element can pass the optical path of the light beam produced by the optical sensor. The light-blocking element has a detecting region such that the optical sensor can detect the detecting region.

According to one embodiment of the present invention, the optical sensor comprises a light-emitting portion and a light-detecting portion. The detecting region of the light-blocking element is permitted to pass through a space between the light-emitting portion and the light-detecting portion of the optical sensor. In addition, the detecting region is an opaque region, for example.

According to one embodiment of the present invention, the optical sensor comprises a light-emitting portion and a light-detecting portion. Furthermore, the detecting region comprises a reflecting region for reflecting the light beam back to the light-detecting portion.

In brief, the present provides an optical control apparatus having a plate and an optical sensor or a light-blocking element and an optical sensor. Since the optical control apparatus occupies a small operating space and does not depend on the number of optical discs that can be stored inside the disc cassette, an identical size plate or light-blocking element can be used in any disc drive with a disc cassette having whatever disc storage capacity.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram showing the layout of components inside a conventional multi-disc drive.

FIG. 2A is a perspective view showing a portion of the structure of a conventional disc drive.

FIG. 2B is a perspective view showing the structure of a detecting unit inside a conventional disc drive.

FIG. 3A is a diagram showing an optical meter in a position to block a light beam from an optical sensor.

FIG. 3B is a diagram showing an optical meter in a position to allow the passage of a light beam from an optical sensor.

FIG. 4A is a diagram showing the layout of components inside a multi-disc drive according to a first embodiment of the present invention.

FIG. 4B is a diagram showing the disc selecting mechanism according to one embodiment of the present invention.

FIG. 5A is a perspective view showing the optical control apparatus according to the first embodiment of the present invention.

FIG. 5B is a diagram showing a plate blocking the light beam emitted from an optical sensor according to the present invention.

FIG. 5C is a diagram showing a plate permitting the passage of a light beam emitted from an optical sensor according to the present invention.

FIG. 6 is a top view of an optical control apparatus according to a second embodiment of the present invention.

FIG. 7 is a perspective view of an optical control apparatus according to a third embodiment of the present invention.

FIG. 8 is a top view of an optical control apparatus according to a fourth embodiment of the present invention.

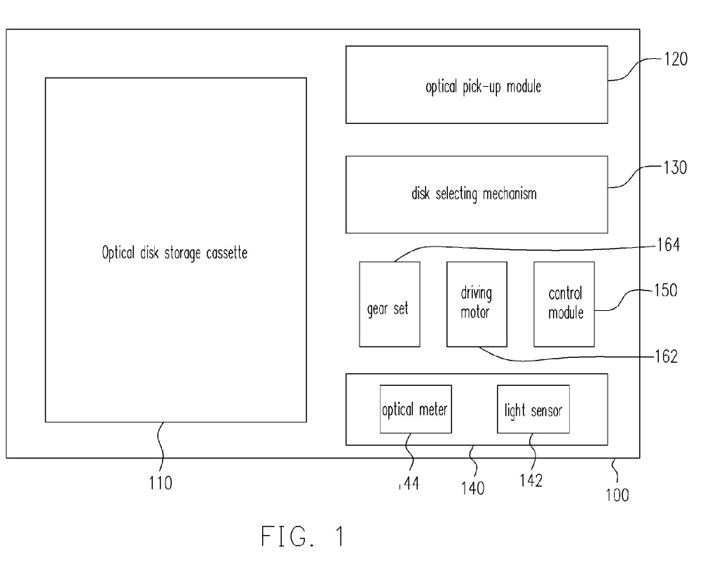

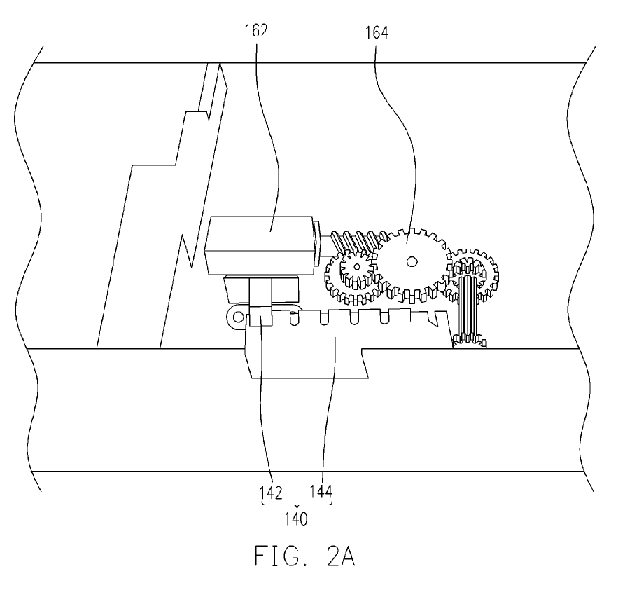

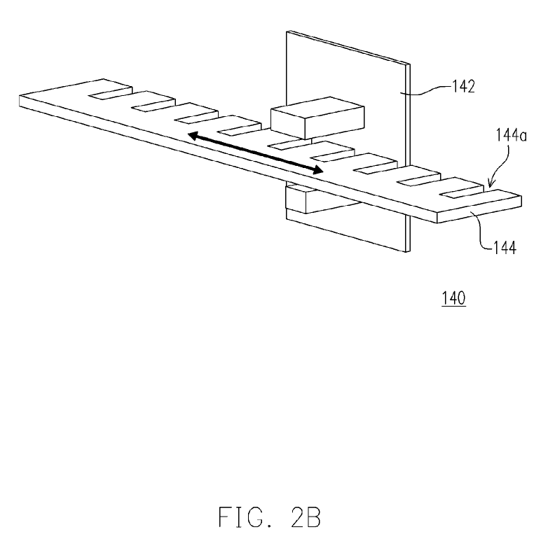

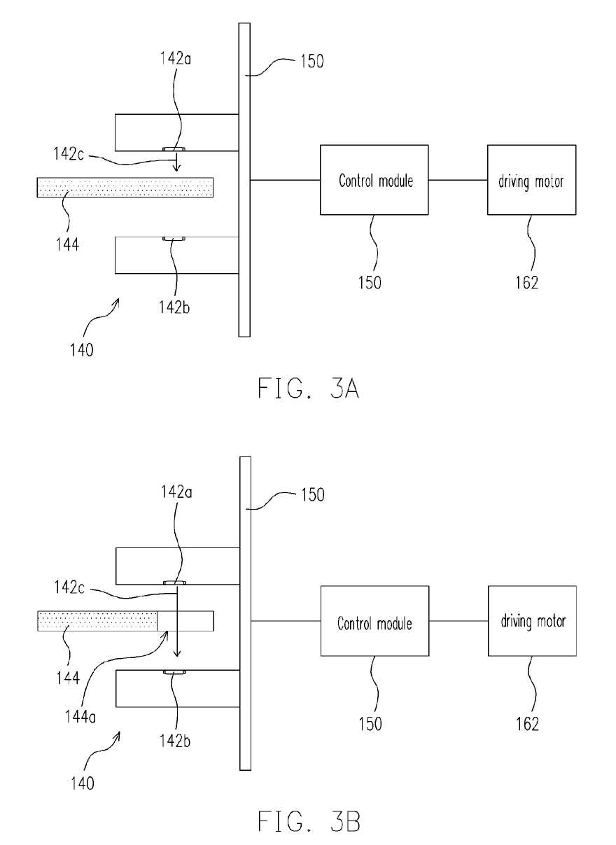

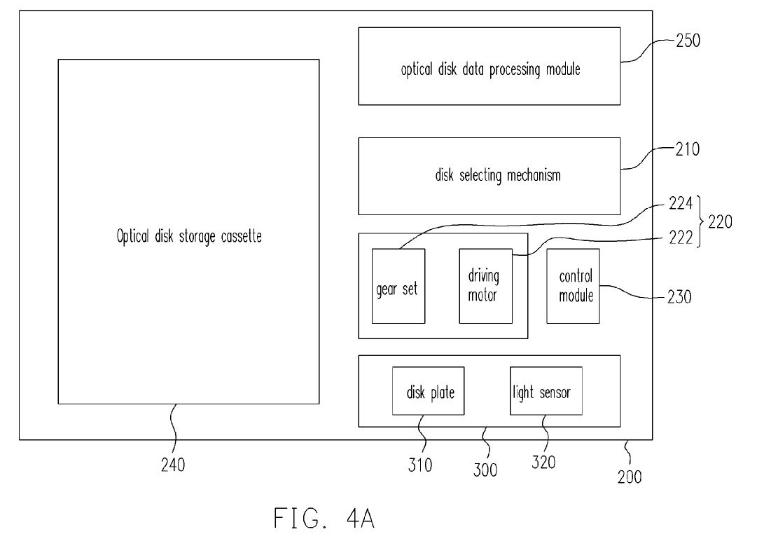

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

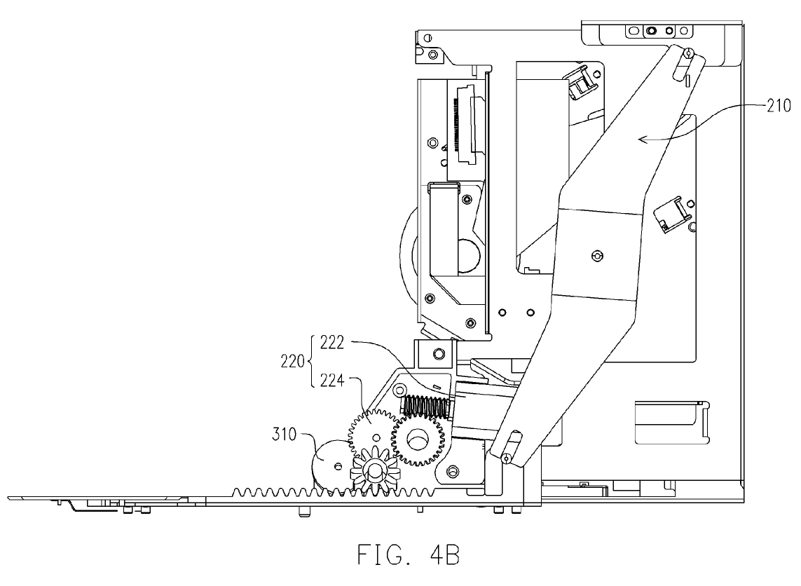

FIG. 4A is a diagram showing the layout of components inside a multi-disc drive according to a first embodiment of the present invention. FIG. 4B is a diagram showing the disc selecting mechanism according to one embodiment of the present invention. As shown in FIGS. 4A and 4B, the optical control apparatus 300 is inside a disc drive 200 that comprises at least a disc selecting mechanism 210, a driving module 220, a control module 230, an optical disc storage cassette 240, and a data processing module 250. The disc selecting mechanism 210 is suitable to operate in an operating space. The optical disc storage cassette 240 and the data processing module 250 are disposed within the operating space of the disc selecting mechanism 210. The driving module 220 drives the disc selecting mechanism 210 to swap optical discs, and the control module 230 controls the driving module 210. In addition, the driving module 220 comprises a driving motor 222 and a gear set 224. The driving motor 222 drives the disc selecting mechanism 220 through the gear set 224 to perform an optical disc changing operation. It should be noted that the present invention does not limit the driving module 220 to a system with a driving motor 222 and a gear set 224. The driving module 220 may comprises a set of levers, transmission belt or other mechanisms capable of driving the disc selecting mechanism 210 to perform an optical disc changing operation.

The optical control apparatus 300 mainly comprises a plate 310 and an optical sensor 320. The optical sensor 320 is electrically connected to the control module 230. The plate 310 rotates when driven by the control module 220 via the driving motor 222 and the gear set 224. In addition, the disc selecting mechanism 210 and the plate 310 are driven by the driving module simultaneously. In other words, the height of the disc selecting mechanism 210 can be estimated through the angle of rotation of the plate 310.

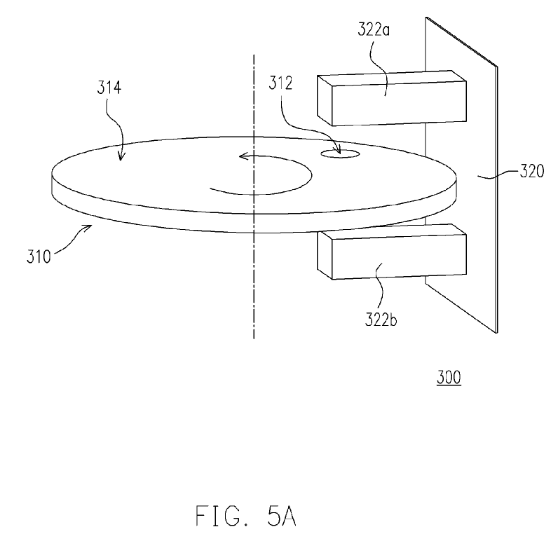

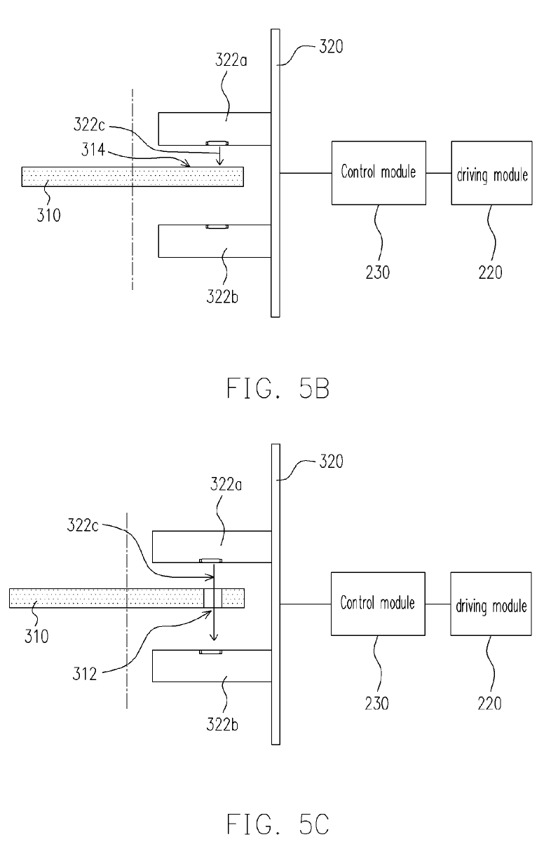

FIG. 5A is a perspective view showing the optical control apparatus according to the first embodiment of the present invention. As shown in FIG. 5A, the optical sensor 320 comprises a light-emitting portion 322a and a light-detecting portion 322b disposed at each side of the plate 310. The light-emitting portion 322a emits a light beam 322c toward the light-detecting portion 322b. At least a portion of the plate is disposed on the optical path of the light beam 322c. It should be noted that the plate 310 has at least a detecting region 312 and a non-detecting region 314. After rotating the plate 310 by a predetermined angle, the optical sensor 320 is able to detect the detecting region 312.

According to the first embodiment of the present invention, the detecting region 312 is a transparent region and the non-detecting region 314 is an opaque region, for example. When the detecting region (the transparent region) 312 is located between the light-emitting portion 322a and the light-detecting portion 322b, the light beam 322c emitted from the light-emitting portion 322a reaches the light-detecting portion 322b unhindered. On the contrary, when the non-detecting region (the opaque region) 314 is located between the light-emitting portion 322a and the light-detecting portion 322b, the light beam 322c from the light-emitting portion 322a is prevented from reaching the light-detecting portion 322b. The operation of the optical control apparatus is explained in more detail in the following.

FIG. 5B is a diagram showing a plate blocking the light beam emitted from an optical sensor according to the present invention. FIG. 5C is a diagram showing a plate permitting the passage of a light beam emitted from an optical sensor according to the present invention. As shown in FIGS. 5B and 5C, the driving module 220 drives the disc selecting mechanism 210 as well as the plate 310 simultaneously. Thus, the disc selecting mechanism 210 and the plate 310 operate simultaneously. When the non-detecting region (the opaque region) 314 of the plate 310 is located between the light-emitting portion 322a and the light-detecting portion 322b, the light-detecting portion 322b is prevented from receiving the light beam 322c sent from the light-emitting portion 322a (as shown in FIG. 5B). Hence, the driving module 220 will continue to drive the disc selecting mechanism 210. However, as the plate 310 is rotated to an angle such that the detecting region (the transparent region) 312 is located between the light-emitting portion 322a and the light-detecting portion 322b, the light beam 322c is able to reach the light-detecting portion 322b (as shown in FIG. 5C). In this case, the optical sensor 320 outputs an electrical signal to the control module 230. According to the electrical signal, the control module 230 instructs the driving module 220 to stop the operation so that the disc selecting mechanism 210 can stop at the required height level. It should be noted that the detecting region (the transparent region) 312 comprises one or more than one through holes or a transparent region fabricated using any transparent material and the non-detecting region 314 is an opaque region fabricated using any opaque substrate. In another embodiment, the detecting region 312 is an opaque region while the non-detecting region 314 is a transparent region, for example.

Assume the disc selecting mechanism 210 is used with a disc cassette capable for holding ten optical discs. And the plate 310 is designed to complete one revolution when the disc selecting mechanism 210 moves from a height level corresponding to the first optical disc to the second optical disc. Meanwhile, the light beam 322c is blocked and then the optical sensor 320 again detects the light beam 322c from the light-emitting portion 322a exactly once. In other words, when the disc selecting mechanism 210 moves from a height level corresponding to the first optical disc to the tenth optical disc, the plate 310 has completed exactly ten revolutions and the optical sensor 320 has detected the light beam 322c exactly nine times. As the number of optical disc stored inside the disc cassette is increased, there is no need to modify the plate 310 or any accessory components. The only difference between a disc drive holding a different number of optical discs is the number of rotations of the plate 310 when the disc selecting mechanism moves from the first to the last optical disc.

It should be noted that the number of detecting region 312 in the plate 310 is not limited to one. The plate 310 can have a multiple of detecting regions 312. If the plate 310 only one detecting region 312, the control module 220 will drive the plate 310 to rotate 360° and simultaneously drives the disc selecting mechanism 300 to move a unit distance (the difference in height between two neighboring discs). Similarly, if the plate 310 has 2, 3, 4, 5 or 6 detecting regions 312, the control module 220 will drive the plate 310 to rotate 1 80°, 1 20°, 90°, 72° or 60° and simultaneously drives the disc selecting mechanism 300 to move a unit distance. In other words, if the number of detecting regions 312 in the plate 310 is a positive integer n, the plate 310 will rotate (360/n) degrees when the driving module 220 drives the disc selecting mechanism 300 to move a unit distance. In addition, the detecting region 312 in the plate 310 is not limited to a transparent region or a non-transparent region. Other types of designs can be applied to the plate 310 as well.

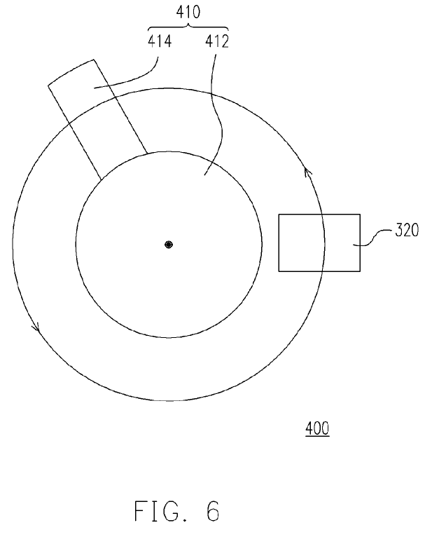

FIG. 6 is a top view of an optical control apparatus according to a second embodiment of the present invention. In the second embodiment, components identical or similar to the components in the first embodiment are labeled identically. As shown in FIG. 6, one major difference from the first embodiment is that the detecting region 414 of the plate 410 in the optical control apparatus 400 is a protruding section from a non-detecting region 412 of the plate 410. The detecting region 414 is an opaque region and the non-detecting region 412 can be fabricated from any substance. When the plate 410 revolves once, the detecting region (the opaque region) 414 blocks the light beam 322c from the optical sensor 320 as shown in FIG. 5B. Thereafter, the optical sensor 320 outputs an electrical signal to the control module 230 so that the control module 230 is able to control the driving module 220 as shown in FIG. 5B. In addition, the number of detecting regions 414 in the plate 410 is not limited to one. The plate 410 can have a multiple of detecting regions 414. It should be noted that the disposition of the light-emitting portion 322a and the light-detecting portion 322b of the optical sensor 320 in the first and the second embodiment are not limited to the respective sides of the plate 310 or 410. The light-emitting portion 322a and the light-detecting portion 322b can be disposed at the same side of the plate 310 or 410 as described in the following.

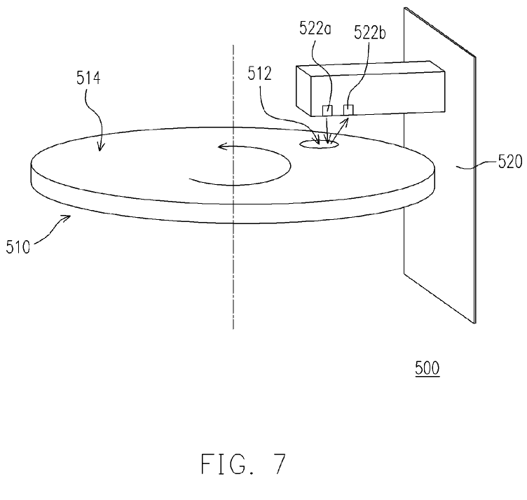

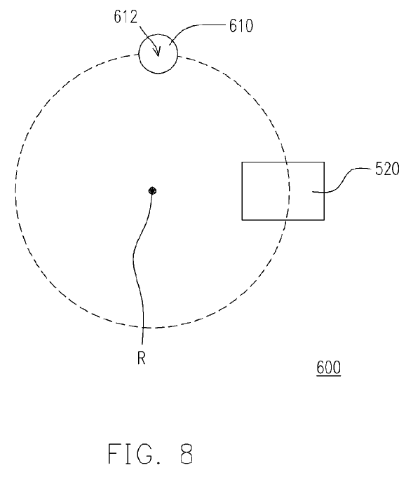

FIG. 7 is a perspective view of an optical control apparatus according to a third embodiment of the present invention. As shown in FIG. 7, the third embodiment is similar to the first embodiment. One major difference from the first embodiment is that the light-emitting portion 522a and the light-detecting portion 522b of the optical sensor 520 are disposed at the same side of the plate 510. In other words, the optical sensor 520 in the optical control apparatus 500 can be disposed above or below the plate 510. Furthermore, the plate 510 comprises a detecting region 512 (for example, a reflecting region) and a non-detecting region 514 (for example, a non-reflecting region). The optical sensor 520 is designed to detect the detecting region 512. In another embodiment, the detecting region 512 is a non-reflecting region while the non-detecting region 514 is a reflecting region. In addition, the number of detecting regions 512 in the plate 510 is not limited to one. The plate 510 can have a plurality of detecting regions 512.

FIG. 8 is a top view of an optical control apparatus according to a fourth embodiment of the present invention. As shown in FIG. 8, the fourth embodiment is similar to the first embodiment. One major difference from the first embodiment is that the light-blocking element 610 can be indirectly driven to rotate around a central axle R through a driving module such as a set of levers or a gear set (not shown). In addition, the light-blocking element 610 has a detecting region 612 such as a reflecting region. The optical sensor 520 is designed to detect the detecting region 612 in the light-blocking element 610 and disposed on the moving path of the light-blocking element 610 such that the light-blocking element 610 can pass the optical path of the light beam emitted from the optical sensor 520. It should be noted that the present invention does not limit the light-blocking element 610 to rotate around a central axle R. In fact, the light-blocking element 610 may move in a closed loop such as a circular path, a rectangular path or other types of regular paths. The closed loop can even be an irregular path.

It should be noted that the contents disclosed in the first, the second, the third and the fourth embodiment of the present invention can be combined in various ways.

In summary, major advantages of the optical control apparatus of the present invention includes:
1. The same plate or light-blocking element and optical sensor can still be used as the number of optical disc stored inside a disc cassette is increased. Only the number of rotations of the plate or the light-blocking element is altered. Since there is no need to modify the plate or the light-blocking element and the optical sensor, the optical control apparatus is unaffected by the storage capacity of the disc cassette.
2. The optical control apparatus can be directly used in different disc drives (having a capacity to hold a different number of optical discs) without any modification.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical control apparatus for a disc drive comprising a disc selecting mechanism, a driving module, a control module, an optical disc storage cassette and an data processing module, wherein the disc selecting mechanism is suitable to operate in an operating space, the optical disc storage cassette and the data processing module are disposed within the operating space, and the driving module drives the disc selecting mechanism while the control module controls the driving module, the optical control apparatus comprising:
an optical sensor electrically connected to the control module, wherein the optical sensor is designed to emit a light beam and detect the light beam; and
a plate, the plate and the disc selecting mechanism are driven by the driving module simultaneously, and the plate is driven by the driving module to rotate, wherein at least a portion of the plate is disposed on an optical path of the light beam emitted from the optical sensor, and the plate has at least a detecting region such that the optical sensor detects the detecting region after the plate has rotated a predetermined angle.

2. The optical control apparatus of claim 1, wherein the predetermined angle of rotation of the plate is 360°, 1 80°, 1 20°, 90°, 72° or 60°.

3. The optical control apparatus of claim 1, wherein the optical sensor comprises a light-emitting portion and a light-detecting portion disposed at each side of the plate, respectively.

4. The optical control apparatus of claim 3, wherein the detecting region comprises a transparent region.

5. The optical control apparatus of claim 4, wherein the transparent region comprises at least a through hole.

6. The optical control apparatus of claim 3, wherein the plate further comprises a non-detecting region and the detecting region is a section protruding from the edge of the non-detecting region.

7. The optical control apparatus of claim 3, wherein the detecting region further comprises an opaque region.

8. The optical control apparatus of claim 1, wherein the optical sensor comprises a light-emitting portion and a light-detecting portion disposed at one side of the plate.

9. The optical control apparatus of claim 8, wherein the detecting region comprises a reflecting region.

10. The optical control apparatus of claim 8, wherein the plate further comprises a non-detecting region and the detecting region is a section protruding from the edge of the non-detecting region.

11. The optical control apparatus of claim 8, wherein the detecting region comprises a non-reflecting region.

12. The optical control apparatus of claim 1, wherein the driving module comprises a gear set and a driving motor such that the driving motor drives the plate and the disc selecting mechanism through the gear set while the control module controls the driving motor.

13. An optical control apparatus for a disc drive comprising a disc selecting mechanism, a driving module, a control module, an optical disc storage cassette and an data processing module, wherein the disc selecting mechanism is suitable to operate in an operating space, the optical disc storage cassette and the data processing module are disposed within the operating space, and the driving module drives the disc selecting mechanism while the control module controls the driving module, the optical control apparatus comprising:
an optical sensor electrically connected to the control module, wherein the optical sensor is designed to emit a light beam and detect the returning light beam; and
a light-blocking element, the light-blocking element and the disc selecting mechanism are driven by the driving module simultaneously, and the light-blocking element is driven by the driving module to rotate around a rotation axle, wherein the optical sensor is disposed on the moving path of the light-blocking element such that the light-blocking element can pass the optical path of the light beam emitted from the optical sensor, and the light-blocking element has at least a detecting region such that the optical sensor detects the detecting region.

14. The optical control apparatus of claim 13, wherein the optical sensor comprises a light-emitting portion and a light-detecting portion, and the detecting region of the light-blocking element is designed to pass between the light-emitting portion and the light-detecting portion.

15. The optical control apparatus of claim 14, wherein the detecting region comprises a transparent region.

16. The optical control apparatus of claim 13, wherein the optical sensor comprises a light-emitting portion and a light-detecting portion, and the detecting region comprises a reflecting region such that the light beam is reflected to the light-detecting portion after a reflection from the reflecting region.
